(19) United States
(12) Patent Application Publication
(10) Pub. No.: US 2026/0289493 A1
(43) Pub. Date: Sep. 24, 2026

(54) DATA-DRIVEN DECISION-SUPPORT SYSTEM FOR SENSOR-ENABLED FOOD SUPPLY CHAINS

(71) Applicant: The Curators of the University of Missouri, Columbia, MO (US)

(72) Inventors: Haitao Li, St. Louis, MO (US); Kate Trout, Columbia, MO (US); Amit Morey, Auburn, AL (US)

(73) Assignee: Auburn University, Aubrun, AL (US)

(21) Appl. No.: 19/085,703

(22) Filed: Mar. 20, 2025

(51) Int. Cl. G06Q 10/087; G06Q 10/047; G06Q 10/0832

(52) U.S. Cl. CPC G06Q 10/087; G06Q 10/047; G06Q 10/0832

(57) ABSTRACT

A distribution optimization system and method for optimizing distribution of a perishable good. The system includes a data warehouse for storing operational data and a distribution controller operably coupled to the data warehouse and configured to produce an optimized distribution supply chain path for the perishable good. The operational data is gathered from a plurality of sources associated with the perishable good. The distribution controller includes a central processor and a memory. The memory stores processor-executable instructions that, when executed by the central processor, configure the distribution controller for: receiving the operational data associated with the perishable good from the data warehouse and executing an optimization model to prescribe an optimized supply chain distribution path for the perishable good based on the operational data.

### GOVERNMENT RIGHTS

This invention was made with government support under grant number 2344877 awarded by the National Science Foundation. The government has certain rights in the invention.

### FIELD

The present disclosure generally relates to a system and method for distribution optimization in food supply chains.

### BACKGROUND

Unsafe food consumption is a major global health concern, causing approximately 600 million cases of foodborne illness and 420,000 deaths annually worldwide. In the United States, foodborne diseases remain a significant problem, with Salmonella being a leading cause. Each year in the US, Salmonella is responsible for 1.35 million infections, 26,500 hospitalizations, and 420 deaths. Despite national efforts to improve food safety, the incidence of Salmonella infections has not decreased in the past three decades. The economic impact of Salmonella in the US is substantial, costing an estimated $3.7 billion annually in medical expenses, lost productivity, and deaths. This burden disproportionately affects vulnerable populations, including those with lower socioeconomic status and underrepresented ethnic groups, further exacerbating financial challenges for individuals already facing difficulties

Efforts to tackle Salmonella and other pathogens have historically been siloed due to the lack of an integrated data environment across an end-to-end (farm-to-fork) supply chain, making it difficult to implement and evaluate the policies and interventions to reduce infections. The lack of integrated data on population health, poultry/food production, and environment has resulted in the absence of coordinated, evidence-based food safety decision systems along the supply chain.

Existing systems for pathogen detection are slow, expensive, generally separate from key elements in supply chain processes, and in various modes can fail to adequately differentiate and quantify pathogens. The lack of portability of such systems, the fact that they often require shipping samples and/or sample data to remote labs, and the inability to sufficiently track, organize, authenticate, and contextualize such data with data from supportive sensors has made the work of ensuring safe, well-monitored supply chains very difficult.

### SUMMARY

In one aspect, the present disclosure provides a distribution optimization system includes a data warehouse for storing operational data and a distribution controller operably coupled to the data warehouse and configured to produce an optimized distribution supply chain path for a perishable good. The operational data is gathered from a plurality of sources associated with the perishable good. The distribution controller includes a central processor and a memory. The memory stores processor-executable instructions that, when executed by the central processor, configure the distribution controller for: receiving the operational data associated with the perishable good from the data warehouse and executing an optimization model to prescribe an optimized supply chain distribution path for the perishable good based on the operational data.

In another aspect, the present disclosure provides method for distribution optimization. The method includes monitoring a quality of a perishable good using one or more sensors, receiving operational data being gathered from a plurality of sources associated with a perishable good, processing the operational data on the central processing device to evaluate the quality of the perishable good, and generating an optimized supply chain distribution path using the central processing device based on identified opportunities for optimizing distribution. Receiving the operational data includes receiving sensor data from the one or more sensors at an input of a central processing device, receiving a perishable good constraint at the input of the central processing device, and receiving at least one supply chain constraint at the input of the central processing device. Processing includes executing, by the central processing device, one or more machine learning algorithms.

In yet another aspect, the present disclosure provides method for optimizing delivery of a perishable good. The method includes inputting one or more constraints associated with a perishable good and distribution at an input of a distribution optimization system and performing an optimization model algorithm on a central processing device of the distribution optimization system. Next, the method includes preparing the optimized supply chain distribution path using the one or more constraints and the optimization model and implementing the optimized supply chain distribution path.

Other objects and features of the present invention will be in part apparent and in part pointed out herein.

### BRIEF DESCRIPTION OF THE DRAWINGS

FIG. 1 is a flow diagram of a distribution optimization system according to an embodiment of the present disclosure.

FIG. 2 is a schematic illustration showing the distribution optimization system.

FIG. 3 is a flow diagram of a poultry supply chain and placement of a plurality of sensors throughout the supply chain.

FIG. 4 is a map diagram showing a prediction made by the distribution optimization system.

FIG. 5 is a schematic illustration showing the distribution optimization system according to an embodiment of the present disclosure.

FIG. 6 is a schematic illustration showing the distribution optimization system according to an embodiment of the present disclosure.

FIG. 7 is a flow diagram of a plurality of supply chain distribution paths.

FIG. 8 is a flow chart illustrating the steps of a method for distribution optimization.

FIG. 9 a flow chart illustrating the steps of a method for making a distribution plan for a perishable good delivery for implementation.

FIG. 10 is a flow diagram of implementing an optimized supply chain distribution path.

FIG. 11 is a flow diagram of an example process for making a distribution plan for a perishable good delivery.

FIG. 12 a schematic illustration of the SENSD sensing system.

FIG. 13 a schematic illustration of a sensing platform of the SENSD sensing system of FIG. 12.

FIG. 14 a schematic illustration of a sensing platform of the SENSD sensing system of FIG. 12 including a computer.

Corresponding reference characters indicate corresponding parts throughout the drawings.

### DETAILED DESCRIPTION

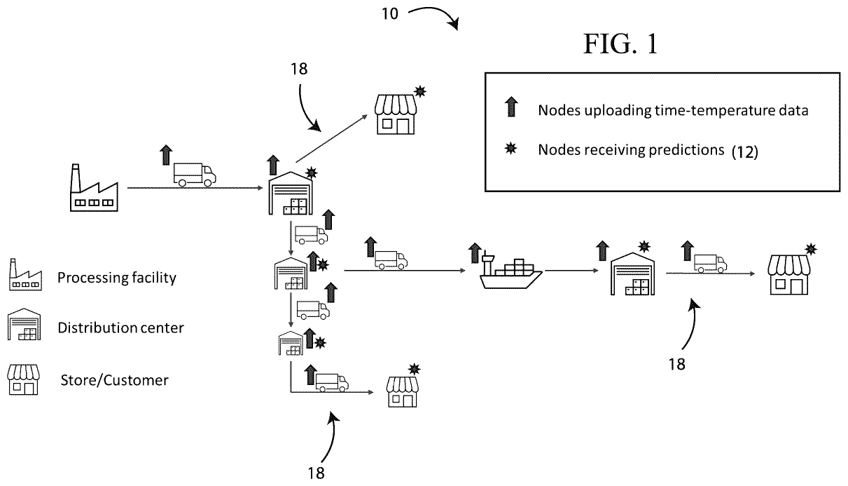

Referring to the drawings, FIGS. 1-3, the distribution optimization system 10 is used for monitoring a perishable good throughout processing and transport through a supply chain, sharing data related to the perishable good, and providing a risk analysis associated with the perishable good. Throughout the supply chain, data regarding the condition of the perishable good is received by the system 10 and predictions 12 regarding the perishable good's contamination exposure is provided by the system 10. The predictions 12 may be received, for example, but not limitation, when the perishable good is being processed, upon arrival to a destination, or remotely while the perishable good is in transit. In an embodiment, the perishable good is a food item within a supply chain. By way of example, and not limitation, the food item may be chicken that is proceeded into a plurality of chicken products, (e.g., raw chicken, semi-cooked chicken, cooked chicken) intended to be transported through the supply chain.

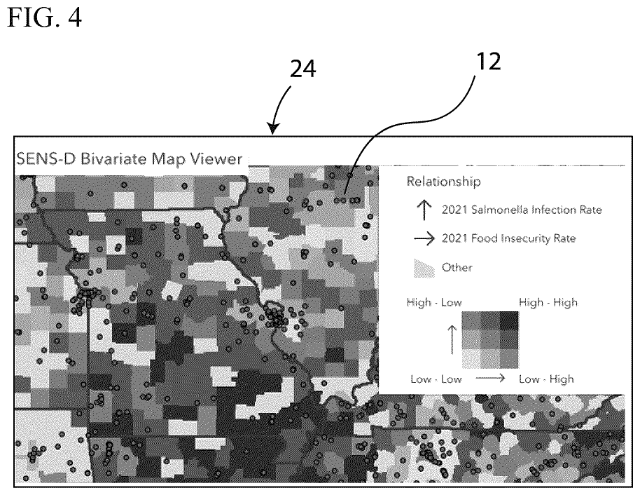

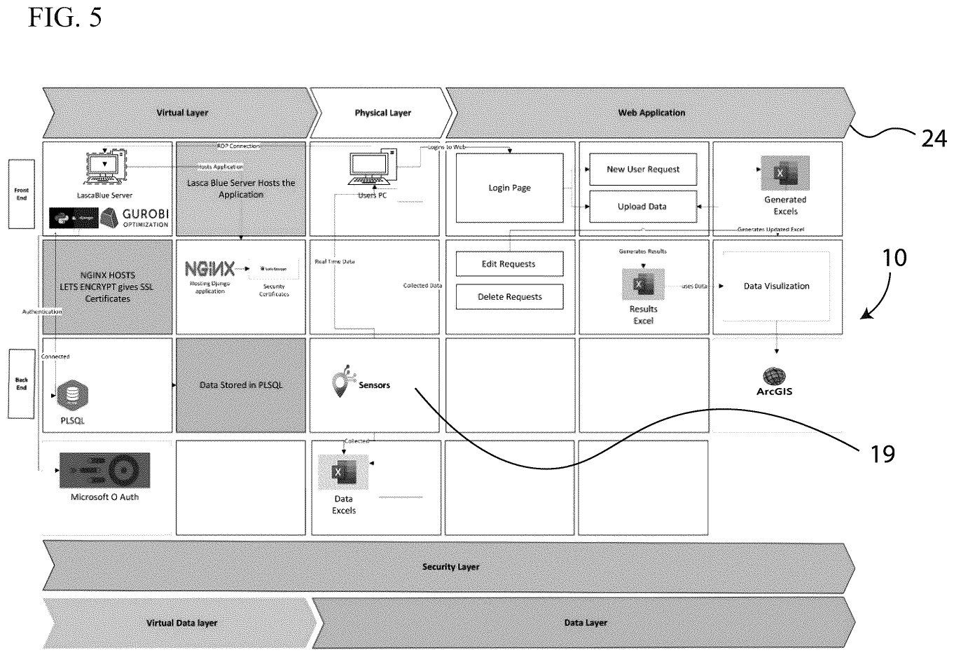

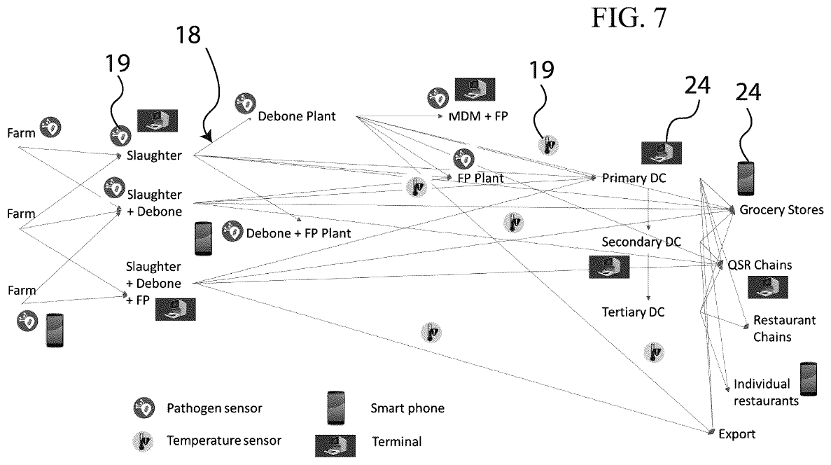

Referring to FIGS. 4-7, the distribution optimization system 10 includes a data warehouse 14 and a distribution controller 16 operably coupled to the data warehouse and used to produce a plurality of distribution supply chain paths 18, which includes an optimized distribution supply chain path for the perishable good.

The data warehouse 14 stores real-time and historical operational data to be used by the system 10 for prescribing an optimized supply chain distribution path 18. The operational data is gathered from a plurality of sources associated with the perishable good. In an embodiment, the plurality of sources by way of example, and not limitation, include at least one sensor 19, a supply chain operation records, a database of geospatial data, a database of population data, and a database of health data. In an embodiment, the data warehouse 14 may be locally stored within the system 10. In an alternative embodiment, the data warehouse 14 may be within a cloud. The system 10 seamlessly integrates data sources and ensures data integrity and security, making it particularly suitable for industries dealing with sensitive data, such as agriculture and food safety. For example, when the data warehouse 14 is within the cloud, the system 10 is an integrated cloud-based system designed for real-time and historical data collection, processing, management, and analysis across multiple sectors, including healthcare, public health, finance, logistics, food production, and agriculture.

In an embodiment, distribution controller 16 includes a central processor 20 and a memory 22. The memory 22 stores processor-executable instructions that are executed by the central processor 20. The memory 22 stores processor-executable instructions that, when executed by the central processor 20, the distribution controller 16 is able to model, by the optimization algorithm, a plurality of distribution supply chain paths and may determine which of the plurality of distribution supply chain paths is optimal based on the one or more factors weighted. When executed, the central processor 20 receives the operational data associated with the perishable good from the data warehouse 14 and executes an optimization model and algorithm to prescribe an optimized supply chain distribution path 18 for the perishable good based on the operational data. The central processor 20 is able to simultaneous process and analyze real-time and historical data from the plurality of sources. According to aspects of the present disclosure, optimization methods (e.g., mathematical programming) are used here to prescribe optimal distribution plan (the so-called intelligent distribution). Prescriptive analytics as described herein employ optimization methods for decision-makers.

To prescribe an optimized supply chain distribution path 18, the central processor 20 executes the optimization algorithm, which weighs one or more factors. The factors can be inputted into the optimization algorithm by the user or can be set within the optimization algorithm.

The inputs to the optimization algorithm include, but are not limited to, cost amount, an environment condition, an industry requirement, spatial-temporal spread of pathogen contamination, a shelf-time of the perishable good, and a population risk. The cost amount can be indicative of a cost associated with moving or removing the perishable good through the supply chain. The environment condition can include temperature, humidity, or other environmental conditions, such as weather patterns or transportation logistics. The industry requirement may be origin of the flock, pre-harvest food safety interventions, feed withdrawal times, cleanliness scores of live-haul trucks, bird weight, scalder water additives, antimicrobial interventions and their concentrations, chiller water pH, temperature and antimicrobial concentrations, post-chill yield and USDA FSIS compliance category. The spatial-temporal spread of pathogen contamination may be influenced by multiple factors, including environmental conditions, human activity, interactions between animal reservoirs carrying the pathogen, proximity to livestock, seasonal trends, and biological characteristics of the pathogen (e.g. track with metagenomics), time to debone, cleaning and sanitation records (microbial counts and ATP results), marination, antimicrobial intervention in parts, type of packaging, post-packaging handling and storage, time-temperature of cold chain . . . The shelf-time of the perishable good may the the perisable good's orginal use by date prior to transportation. The population risk may be groups with historically high incidence rates, those affected by food insecurity and socioeconomic disparities, and individuals in geographically vulnerable regions. Additionally, certain populations face heightened susceptibility to foodborne illness, including infants and children, elderly, pregnant women, and immunocompromised individuals.

The optimized supply chain distribution path 18 is an output of the optimization algorithms, which may include a cost-optimization, food safety strategies, intelligent distribution, and equity for delivery spread across population to achieve safe food while maintaining efficiency, equity, resilience and sustainability. The system 10 can be further used to recommend safe handling practices to end recipients with collaborators (e.g., extension faculty, social workers, etc.), while collaborating with public health, extension, and outreach for monitoring post-distribution outcomes.

The optimized supply chain distribution path 18 provides a preferred delivery location and one or more delivery conditions. The preferred delivery location and one or more delivery conditions provides a mitigation strategy for reducing loss from delivering non-conforming (e.g., reduced shelf life or expired) perishable goods and provides a strategy for achieving food safety, cost efficiency, and equity. The delivery conditions may include a mode of transport (e.g., road vehicle, ship, train, or plane). Further, the delivery conditions may include temperature for shipment, a profile of shipment and product, a condition of the package, a drip loss, an organoleptic evaluation, and humidity. The optimized supply chain distribution path 18 may further identify optimized sensor placement of the sensors 19 and implementation through the supply chain. Placement of sensors 19 involves determining where to place heterogeneous types of sensors, which differ in performance (e.g., sensitivity and specificity), cost, lead time, resource technician requirement. The optimized distribution supply chain path 18 accounts for placement of at least one sensor, intelligent distribution, and coordinated strategic food systems planning based on population needs. Consumer education, pathogen testing, or additional safety checks are done by considering population demographics, severity of food disparities, transportation logistics and storage capacity, along with predict product shelf-time to optimize the allocation and distribution of supply to meet market demands.

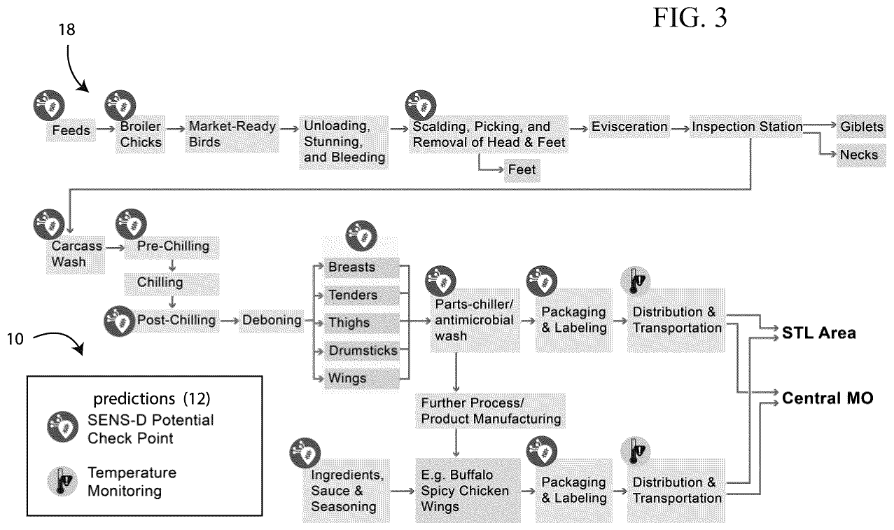

Referring to FIGS. 3-6, the system 10 may include one or more user-interfaces 24. By way of example, and not limitation, the user-interfaces 24 may be through web server dashboards. The user interfaces 24 may be used to input operational data into the system 10. The user interfaces 24 may be accessible by multisector users (e.g., producer, processor, distributor, retailer, food banks) for inputting data and receiving the optimized distribution supply chain path 18. For example, the user interface 24 may allow users to interact with real-time and historical data across multiple sectors. The user interface 24 may include controls and visualization techniques that enable users to filter, explore, and analyze complex data, including geographic pathogen risks, environmental overlays, and demographic vulnerabilities, in a way that enhances usability and improves decision-making in real-time. Referring to FIG. 4, the optimized supply chain distribution path 18 can be displayed through the user-interface 24.

The user-interface 24 displays actionable maps and dashboards with summaries of the distribution supply chain paths and the optimized distribution supply chain path 18. Using the distribution supply chain paths that are identified by the system 10, the optimized distribution supply chain path 18 can be implemented by assigning a location for the perishable good to be directed. The perishable good be further monitored to determine if the optimized distribution supply chain path 18 remains the preferred delivery location or if there needs to be an updated assignment. Further, perishable goods can be further monitored to determine if the optimized distribution supply chain path needs any updated conditions. The preferred delivery location and delivery conditions can change due to adjustments based on delivery issues or recipient feedback.

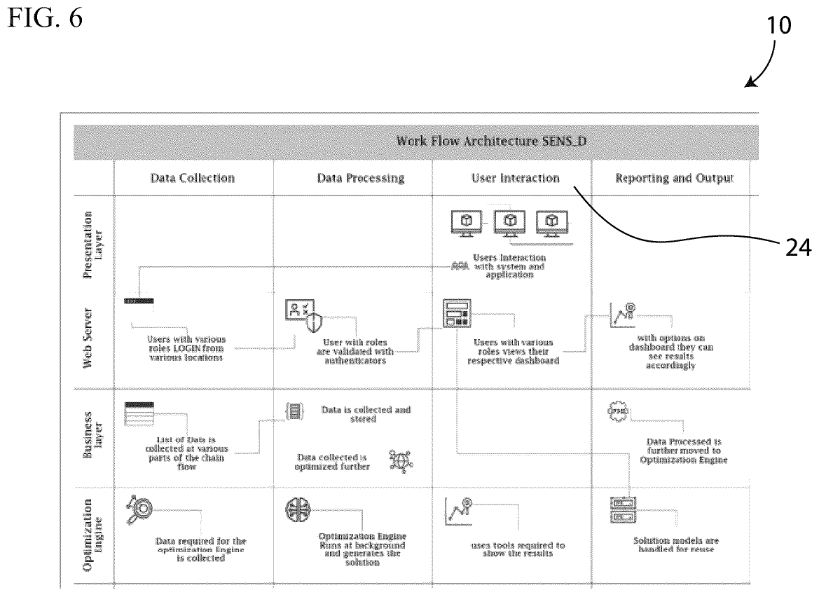

Referring to FIG. 6, the system 10 may include four technical layers as shown in each row: Presentation, Web Server, Business and Optimization Engine; and four application functions as shown in each column: Data Collection, Data Processing, User Interface, and Reporting and Output. The Presentation Layer, which enable users to access and interact with system and application through User Interface. The Web Server Layer: (i) allows a user to login with certain role(s) and privilege to input data, (ii) validates user with proved role(s) with authenticators, (iii) gives user access and privilege to view, edit/modify and execute optimization in the dashboard, and (iv) generates reports and visualizations of results and outputs. The Business Layer organizes the set of data for the input parameters, and processes the data to build objective function and constraints in the optimization models. The Optimization Engine Layer builds the optimization models using the input data, solves the model using optimization algorithms, and generates solutions and results as outputs.

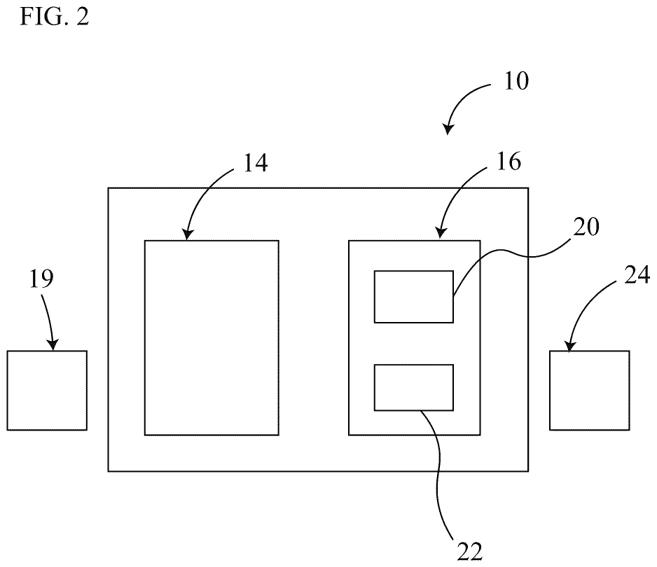

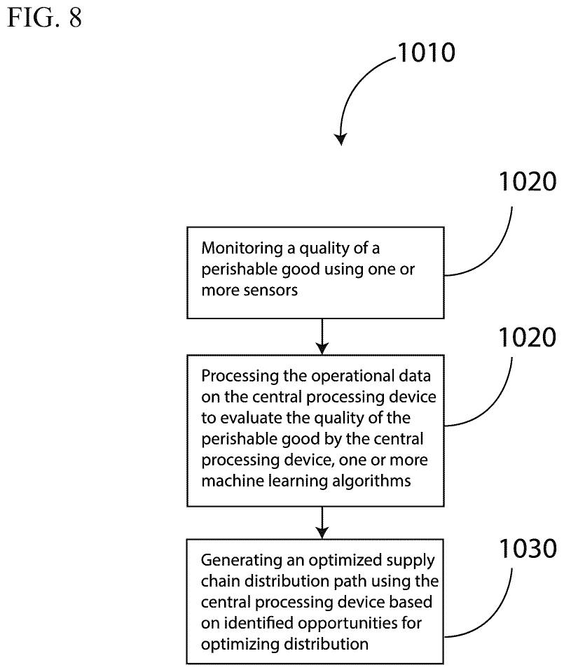

Referring to FIG. 8, FIG. 8 illustrates a method 1010 for distribution optimization including step 1020 of monitoring a quality of a perishable good using one or more sensors 19, receiving operational data being gathered from a plurality of sources associated with a perishable good, receiving a sensor data from the one or more sensors at an input of a central processing device (e.g., FIG. 2), receiving a perishable good constraint at the input of the central processing device, and receiving at least one supply chain constraint at the input of the central processing device. Step 1030 includes processing the operational data on the central processing device to evaluate the quality of the perishable good by the central processing device executing an optimization model. In an embodiment, the optimization model may be implemented by one or more machine learning algorithms. Next, step 1040 includes generating an optimized supply chain distribution path 18 using the central processing device based on identified opportunities for optimizing distribution.

In an embodiment, step 1040 of generating the optimized supply chain distribution path 18 includes executing processor-executable instructions by the one or more optimization model algorithms and a plurality of distribution supply chain paths and predicting which of the plurality of distribution supply chain paths is optimal based on one or more factors weighted. Generating the optimized supply chain distribution path 18 includes further include weighing one or more factors related to the operational data that include one or more of a cost amount, an environment condition, an industry requirement, a spatial-temporal spread of pathogen contamination, a shelf-time, and a population risk.

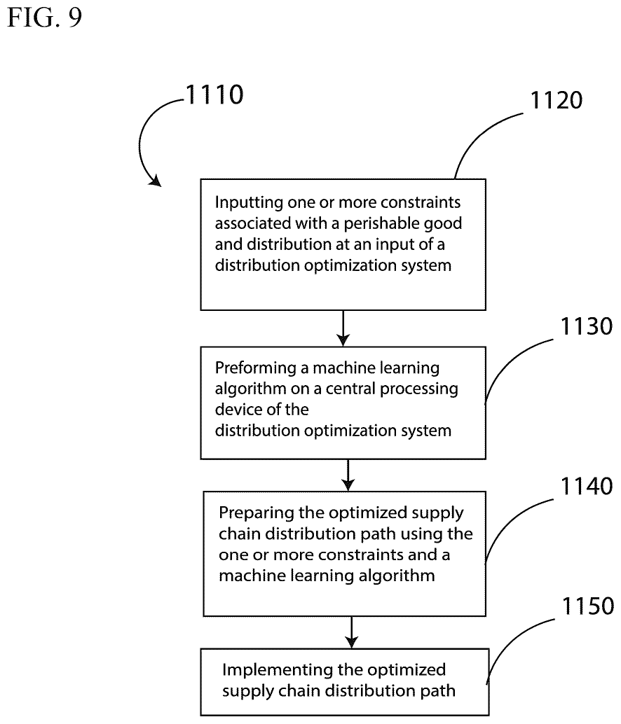

In an embodiment, the method 1010 may further include a method 1110 (FIG. 9) of implementing the optimized supply chain distribution path 18, which can include diverting a perishable good from an initial distribution supply chain path to the optimized supply chain distribution path.

Referring to FIG. 9, FIG. 9 illustrates the method 1110 of making a distribution plan for a perishable good delivery for implementation. The method 1110 includes step 1120 of inputting one or more constraints associated with a perishable good and distribution at an input of a distribution optimization system, step 1130 of performing one or more optimization model algorithms on a central processing device of the distribution optimization system, step 1140 of preparing the optimized supply chain distribution path 18 using the one or more constraints and the optimization model, and step 1150 of implementing the optimized supply chain distribution path. In an embodiment, step 1120 of inputting one or more constraints may include inputting a distribution budget.

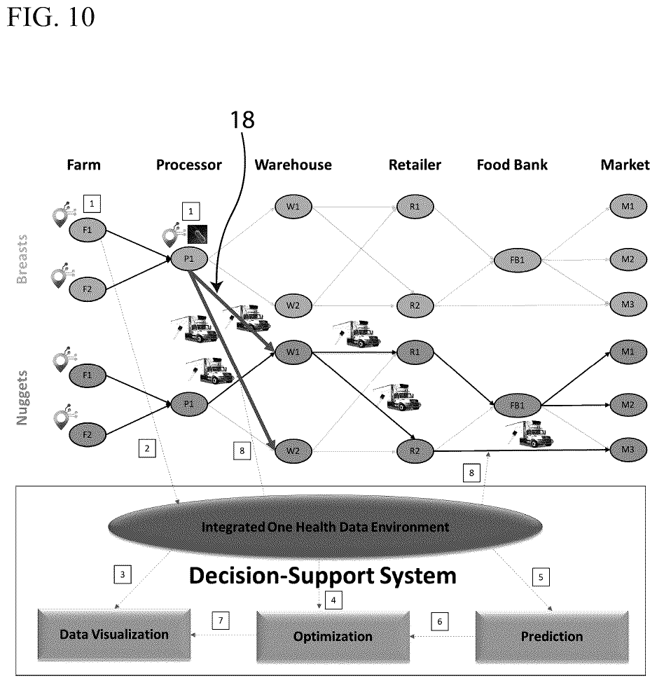

In an embodiment, step 1150 of implementing the optimized supply chain distribution path 18 may include delivering the perishable good to the delivery location with the one or more delivery conditions. Further, step 1150 can include removing the perishable good from a supply chain when the perishable good is non-conforming. For example, referring to FIG. 10, in a case where the good becomes non-conforming by having a reduced-shelf life (e.g., when Salmonella level exceeds the safety threshold as shown at professor P1), the optimized distribution supply chain path 18 will prescribe the diversion of raw chicken breasts to semi-cooked chicken nuggets, such that no raw chicken breast is shipped out of processor P1. The optimized distribution supply chain path 18 will also prescribe optimal distribution path to serve market demands. For example, chicken nuggets can be shipped directly from retailer R2 to serve some food dessert M3 by skipping to a foodbank, due to short product shelf time.

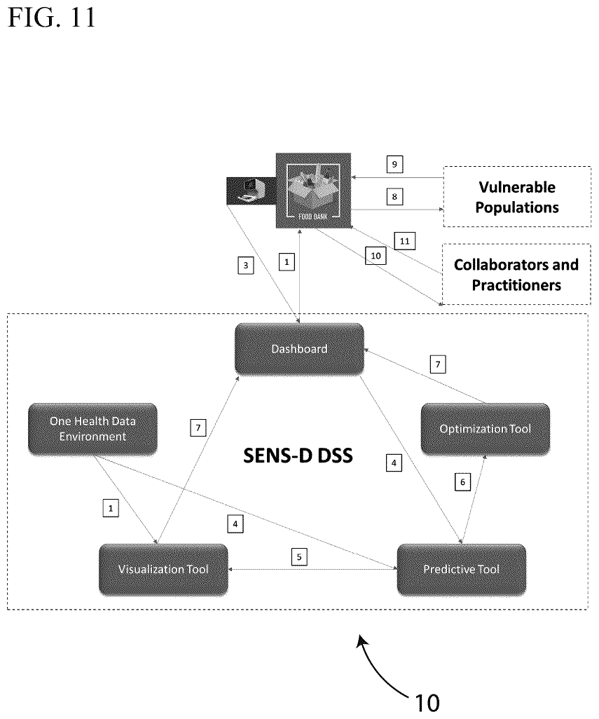

By way of example, and not limitation, a food bank within the supply chain may be informed about a limited supply of poultry products by the system 10. The limited supply may be due to contamination or another factor. Referring to FIG. 11, a personnel of the food bank can input enter information about the poultry product shipment, including type of product, quantity, safety certification, etc. into the system 10. The system 10 uses the inputs from the personnel of the food bank along with the factors to assess: (i) local food insecurity rates (e.g., census data, NGO reports); and (ii) areas with high Salmonella prevalence using predictive analytics and health data. Next, the system 10 outputs, predictions, which may include a spatial-temporal spread of pathogen contamination, shelf-time, and population risks.

For example, the system 10 may identify areas with: (i) high food insecurity; and (ii) high risk of Salmonella -related foodborne illness. This can be outputted as a list or a heatmap (FIG. 4), which indicates high-risk zones (food insecurity and Salmonella rates). Predictive techniques can be done through as econometrics, Bayesian, artificial neural networks, such that the system provides a prediction of the spread of Salmonella contamination, both geographically and temporally, and the shelf-time of poultry products. By taking the aforementioned input data and the predictive results, the system provides solutions to three types of problems: (i) at the strategic level, the system optimizes the placement and implementation of sensors to maximize its performance (sensitivity, timeliness and reliability) in a cost-effectively; (ii) at the operational level, the system 10 optimizes the logistics and transportation of perishable poultry products to minimize loss and waste efficiently and equitably. Example machine learning algorithms may include a large language model (LLM) used to extract insights on socio-economic disparities from the system 10. The system 10 flags areas with highest Salmonella risk and provides an optimized distribution supply chain path 18, which includes mitigation strategies (e.g., consumer education, pathogen testing, or additional safety checks) by considering population demographics, severity of food disparities, transportation logistics and storage capacity, along with predict product shelf-time to optimize the allocation and distribution of supply to meet market demands, while achieving food safety, cost efficiency, and equity. The user-interface 24 displays actionable maps and dashboards with summaries of the distribution supply chain paths. Using the distribution supply chain paths that are identified by the system 10, the food bank can implement the optimized distribution supply chain path 18 and can continue to monitor the good to determine if the optimized distribution supply chain path if further impacted and needs to be updated.

A sensor used as a source for operation data may be located near the perishable good, such as, but not limiting to, within the packaging of the perishable good. Alternatively, or additionally, the sensor may be within a supply chain location, such as, a processing facility, a distribution center, a store, or within a vehicle used for transporting the perishable good.

Referring to FIGS. 1 and 3, the sensor is a temperature sensor to provide temperature measurements as the sensor data. The temperature measurements are indicative of a quality of the perishable good since the amount of time the perishable good is within a too high or too low temperature can be used to determine a current shelf life of the perishable good. In an embodiment, mathematical equations may be used to make the prediction 12 by being used to predicting growth of spoilage organisms and Salmonella on raw poultry at various stages of poultry supply chain by using time-temperature as well as quality of the chicken. Time-temperature data will be collected using IoT sensors at various locations in the poultry supply chain which will feed into the cloud. The models combined with cloud computing and dashboard will provide decision support for stakeholders in the poultry supply chain to reduce food waste and loss while ensuring food safety.

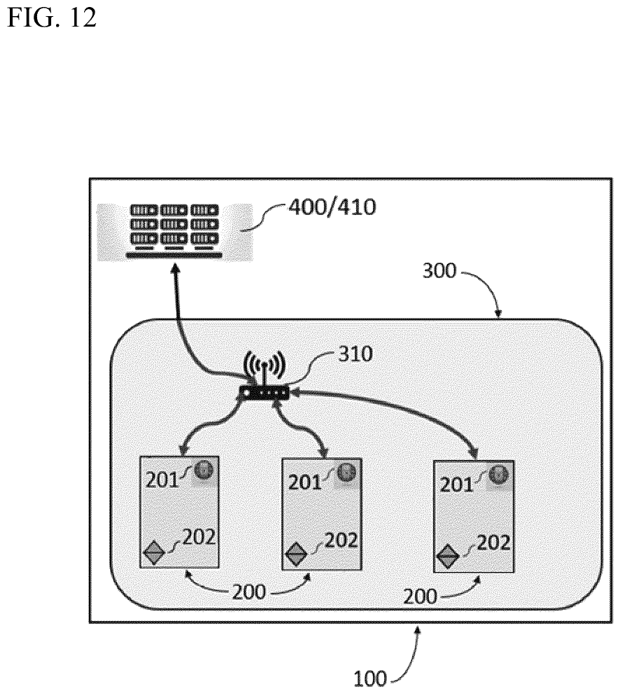

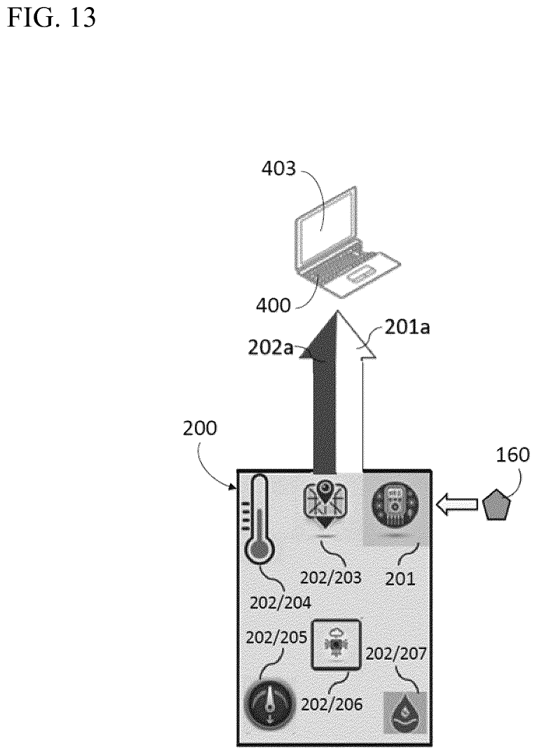

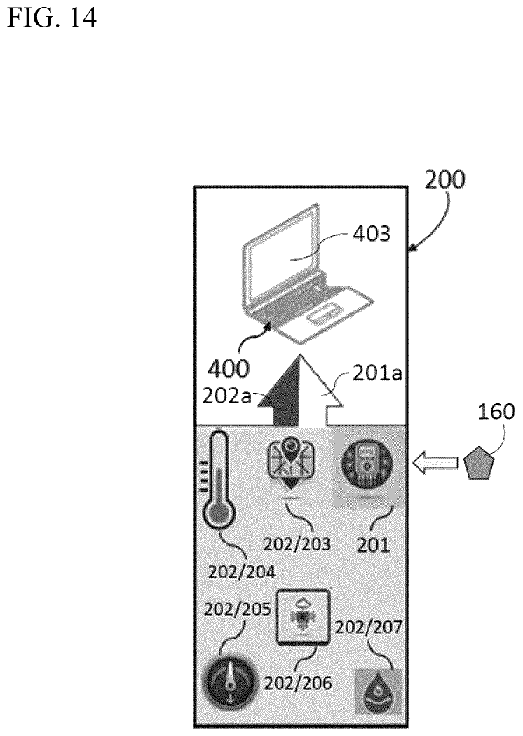

Other sensors may be used without departing from the scope of the present disclosure. By way of example, and not limitation, referring to FIGS. 12-14 other sensors may include pathogen sensors. For example, referring to FIGS. 12-14, the following detailed description comprises disclosure of a sensor-enabled pathogen identification, differentiation, and quantification system that integrates into supply chains in an end-to-end fashion and is built on a multi-source, multi-sectoral data environment. The system 10 may use portable sensing platforms that are easily integrated at multiple points along a supply chain and which integrate sample analysis and data processing such that all necessary work can be performed on-site and/or via wireless data transfer. The system 100 may comprise one or more pathogen sensors, such as impedance sensors, and/or SERS sensors. The system 100 incorporates data from the one or more pathogen sensors, operational data, including data from one or more supportive sensors, and administrative data.

Each of the one or more sensing platforms 200 comprises one or more pathogen sensors 201. Each of the one or more pathogen sensors 201 generates pathogen sensor data 201a in response to contact with a sample of interest 160. The sample of interest 160 can be any physical sample of a substance intended to be processed into a food product or in the process of being processed into a food product, such as a liquid extract from poultry, and can vary for each of the one or more pathogen sensors. For example, a sample of interest 160 can be an extract from a plant or animal treated with a liquid solvent. Each of the one or more sensing platforms 200 can also comprise one or more supportive sensors 202 configured to provide data related to the environment immediately surrounding each of the one or more sensing platforms 200. Each of the one or more supportive sensors generates supportive data 202a. In various embodiments, the one or more supportive sensors 202 can comprise a positioning sensor 203, a temperature sensor 204, a pressure sensor 205, an orientation sensor 206, and/or a humidity sensor 207.

In various embodiments, the pathogen sensor data and the supportive data collected by the one or more pathogen sensors 201 and the one or more supportive sensors 202 can be transmitted via communication with one or more wireless node 310 to the computer. In such an instance, the computer 400 can be a node computing system 410 communicatively connected to the wireless node(s) 310. In various embodiments, the node computing system 410 can be a local distributed system of multiple networked computers configured and enabled to work together to identify and quantify both known and emerging pathogen serotypes of interest in the sample of interest 160. For example, the node computing system 410 can track and identify pathogens such as Salmonella in a poultry-related sample of interest 160 from pathogen sensor data acquired by each of the one or more pathogen sensors 201. In various embodiments, the node computing system 410 can also track the incidence, growth, and/or transformation of signals in the pathogen sensor data related to pathogen serotypes that may be emerging in the environment from which the sample of interest 160 was acquired.

Embodiments of the present invention may comprise a special purpose computer including a variety of computer hardware, as described in greater detail below.

Embodiments within the scope of the present invention also include computer-readable media for carrying or having computer-executable instructions or data structures stored thereon. Such computer-readable media can be any available media that can be accessed by a special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which aspects of the invention may be implemented. Although not required, aspects of the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that aspects of the invention may be practiced in network computing environments with many types of computer system configurations, including personal computers, hand-held devices, multi-processor systems, microprocessor-based or programmable consumer electronics, network PCs, minicomputers, mainframe computers, and the like. Aspects of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing aspects of the invention includes a general purpose computing device in the form of a conventional computer, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory includes read only memory (ROM) and random access memory (RAM). A basic input/output system (BIOS), containing the basic routines that help transfer information between elements within the computer, such as during start-up, may be stored in ROM. Further, the computer may include any device (e.g., computer, laptop, tablet, PDA, cell phone, mobile phone, a smart television, and the like) that is capable of receiving or transmitting an IP address wirelessly to or from the internet.

The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The magnetic hard disk drive, magnetic disk drive, and optical disk drive are connected to the system bus by a hard disk drive interface, a magnetic disk drive-interface, and an optical drive interface, respectively. The drives and their associated computer-readable media provide nonvolatile storage of computer-executable instructions, data structures, program modules, and other data for the computer. Although the exemplary environment described herein employs a magnetic hard disk, a removable magnetic disk, and a removable optical disk, other types of computer readable media for storing data can be used, including magnetic cassettes, flash memory cards, digital video disks, Bernoulli cartridges, RAMs, ROMs, solid state drives (SSDs), and the like.

The computer typically includes a variety of computer readable media. Computer readable media can be any available media that can be accessed by the computer and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media are non-transitory and include, but are not limited to, RAM, ROM, EEPROM, flash memory or other memory technology, CD-ROM, digital versatile disks (DVD) or other optical disk storage, SSDs, magnetic cassettes, magnetic tape, magnetic disk storage or other magnetic storage devices, or any other medium which can be used to store the desired non-transitory information, which can accessed by the computer. Alternatively, communication media typically embody computer readable instructions, data structures, program modules or other data in a modulated data signal such as a carrier wave or other transport mechanism and includes any information delivery media.

Program code means comprising one or more program modules may be stored on the hard disk, magnetic disk, optical disk, ROM, and/or RAM, including an operating system, one or more application programs, other program modules, and program data. A user may enter commands and information into the computer through a keyboard, pointing device, or other input device, such as a microphone, joy stick, game pad, satellite dish, scanner, or the like. These and other input devices are often connected to the processing unit through a serial port interface coupled to the system bus. Alternatively, the input devices may be connected by other interfaces, such as a parallel port, a game port, or a universal serial bus (USB). A monitor or another display device is also connected to the system bus via an interface, such as video adapter. In addition to the monitor, personal computers typically include other peripheral output devices (not shown), such as speakers and printers.

One or more aspects of the invention may be embodied in computer-executable instructions (i.e., software), routines, or functions stored in system memory or non-volatile memory as application programs, program modules, and/or program data. The software may alternatively be stored remotely, such as on a remote computer with remote application programs. Generally, program modules include routines, programs, objects, components, data structures, etc. that perform particular tasks or implement particular abstract data types when executed by a processor in a computer or other device. The computer executable instructions may be stored on one or more tangible, non-transitory computer readable media (e.g., hard disk, optical disk, removable storage media, solid state memory, RAM, etc.) and executed by one or more processors or other devices. As will be appreciated by one of skill in the art, the functionality of the program modules may be combined or distributed as desired in various embodiments. In addition, the functionality may be embodied in whole or in part in firmware or hardware equivalents such as integrated circuits, application specific integrated circuits, field programmable gate arrays (FPGA), and the like.

The computer may operate in a networked environment using logical connections to one or more remote computers. The remote computers may each be another personal computer, a tablet, a PDA, a server, a router, a network PC, a peer device, or other common network node, and typically include many or all of the elements described above relative to the computer. The logical connections include a local area network (LAN) and a wide area network (WAN) that are presented here by way of example and not limitation. Such networking environments are commonplace in office-wide or enterprise-wide computer networks, intranets and the Internet.

When used in a LAN networking environment, the computer is connected to the local network through a network interface or adapter. When used in a WAN networking environment, the computer may include a modem, a wireless link, or other means for establishing communications over the wide area network, such as the Internet. The modem, which may be internal or external, is connected to the system bus via the serial port interface. In a networked environment, program modules depicted relative to the computer, or portions thereof, may be stored in the remote memory storage device. It will be appreciated that the network connections shown are exemplary and other means of establishing communications over wide area network may be used.

Preferably, computer-executable instructions are stored in a memory, such as the hard disk drive, and executed by the computer. Advantageously, the computer processor has the capability to perform operations (e.g., execute computer-executable instructions) in real-time.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A distribution optimization system, comprising:
a data warehouse for storing operational data, the operational data being gathered from a plurality of sources associated with a perishable good;
a distribution controller operably coupled to the data warehouse and configured to produce an optimized distribution supply chain path for the perishable good, the distribution controller including a central processor and a memory, wherein the memory stores processor-executable instructions that, when executed by the central processor, configure the distribution controller for:
receiving the operational data associated with the perishable good from the data warehouse; and
executing an optimization model to prescribe an optimized supply chain distribution path for the perishable good based on the operational data.

2. The distribution optimization system of claim 1, wherein the plurality of sources including at least two of: a sensor, a supply chain operation, a database of geospatial data, a database of population data and a database of health data.

3. The distribution optimization system of claim 1, wherein the operational data comprises sensor data gathered by at least one sensor associated with the perishable good, wherein the sensor data is indicative of a quality of the perishable good.

4. The distribution optimization system of claim 2, wherein the optimized distribution supply chain path accounts for placement of at least one sensor, intelligent distribution, and coordinated strategic food systems planning based on population needs.

5. The distribution optimization system of claim 1, wherein the optimization model weighs one or more factors to produce the optimized supply chain distribution path.

6. The distribution optimization system of claim 5, wherein the one or more factors are related to the operational data, wherein the operational data includes one or more of a cost amount, an environment condition, an industry requirement, spatial-temporal spread of pathogen contamination, a shelf-time of the perishable good, and a population risk.

7. The distribution optimization system of claim 5, wherein the memory stores processor-executable instructions that, when executed by the central processor, further configure the distribution controller for modeling, by the optimization model, a plurality of distribution supply chain paths and predicting which of the plurality of distribution supply chain paths is optimal based on the one or more factors weighted.

8. The distribution optimization system of claim 5, wherein the perishable good comprises a food item.

9. A method for distribution optimization, comprising:
monitoring a quality of a perishable good using one or more sensors;
receiving operational data being gathered from a plurality of sources associated with a perishable good including:
receiving a sensor data from the one or more sensors at an input of a central processing device,
receiving a perishable good constraint at the input of the central processing device, and
receiving at least one supply chain constraint at the input of the central processing device;
processing the operational data on the central processing device to evaluate the quality of the perishable good, wherein processing comprises executing, by the central processing device, one or more machine learning algorithms; and
generating an optimized supply chain distribution path using the central processing device based on identified opportunities for optimizing distribution.

10. The method of claim 9, wherein generating the optimized supply chain distribution path includes weighing factors to produce a cost-optimization.

11. The method of claim 9, wherein generating the optimized supply chain distribution path includes executing processor-executable instructions by the one or more machine learning algorithms and a plurality of distribution supply chain paths.

12. The method of claim 11, wherein generating the optimized supply chain distribution path includes predicting which of the plurality of distribution supply chain paths is optimal based on one or more factors weighted.

13. The method of claim 9, wherein generating the optimized supply chain distribution path includes weighing one or more factors related to the operational data that include one or more of a cost amount, an environment condition, an industry requirement, a spatial-temporal spread of pathogen contamination, a shelf-time, and a population risk.

14. The method of claim 9, further comprising:
implementing the optimized supply chain distribution path, wherein implementing the optimized supply chain distribution path includes diverting a perishable good from an initial distribution supply chain path to the optimized supply chain distribution path.

15. The method of claim 9, further comprising:
displaying the optimized supply chain distribution path through a user-interface.

16. A method of optimizing delivery of a perishable good, comprising:
inputting one or more constraints associated with a perishable good and distribution at an input of a distribution optimization system;
performing an optimization model on a central processing device of the distribution optimization system;
preparing the optimized supply chain distribution path using the one or more constraints and the optimization model;
implementing the optimized supply chain distribution path.

17. The method of claim 16, wherein inputting one or more constraints includes inputting a distribution budget.

18. The method of claim 16, wherein preparing the optimized supply chain distribution path that includes a delivery location and one or more delivery conditions.

19. The method of claim 18, wherein implementing the optimized supply chain distribution path includes delivering the perishable good to the delivery location with the one or more delivery conditions.

20. The method of claim 16, wherein implementing the optimized supply chain distribution path includes removing the perishable good from a supply chain when the perishable good is a non-conforming.
